(19) United States
(12) Patent Application Publication
(10) Pub. No.: US 2004/0028219 A1
(43) Pub. Date: Feb. 12, 2004

(54) Adjustable holder assembly for holding portable phone

(76) Inventor: Jong Hong Lin, Tainan Hsien (TW)

Correspondence Address: CHARLES E. BAXLEY, 5th Floor, 59 John Street, New York, NY, 10038, US

(21) Appl. No.: 10/213,011

(22) Filed: Aug. 6, 2002

(51) Int. Cl. H04M 1/00

(52) U.S. Cl. 379/441

(57) ABSTRACT

An adjustable holder assembly includes a holder for supporting a portable phone and having a socket opening for receiving one end of a base. The base has two flaps and a channel formed on one end. A plug may be used for plugging to such as the sockets of the vehicles. A shank has an end bar received in the channel of the base and adjustably secured to the base at any selected angular position, and another end bar adjustably secured to the plug at any selected angular position, for solidly and adjustably supporting the portable phone closer to the users.

### BACKGROUND OF THE INVENTION

1. Field of the Invention

The present invention relates to a holder, and more particularly to an adjustable holder assembly for adjustably holding mobile or portable phones.

2. Description of the Prior Art

Various kinds of typical holders for holding mobile or portable phones have been developed and widely used today. U.S. Pat. No. 5,790,661 to Patterson discloses one of the typical holders for mobile or portable phones, and comprises a cradle adjustably secured to a mounting plate with a sliding and adjustable engagement of a fastener in a slot of the cradle. However, the cradle may be rotated relative to the mounting plate and may not be extended or disposed or supported in a distance from the mounting plate, and such that the mobile or portable phones may not be adjusted and supported closer to the users.

U.S. Pat. No. 5,187,744 to Eichter discloses the other typical holder for mobile or portable phones, and comprises a holder body adjustably secured to the automobile with a universally adjustable mounting device, which includes one or more coupling sets each having a ball joint. However, the balls may not be solidly secured in place and may be become loose after use, such that the mobile or portable phones may not be stably and solidly supported in place. In addition, the typical holders for the mobile or portable phones may be used for supporting the mobile or portable phones only and do not include speakers or microphones for using the mobile or portable phones without carrying the mobile or portable phones.

The present invention has arisen to mitigate and/or obviate the afore-described disadvantages of the conventional holders for portable phones.

### SUMMARY OF THE INVENTION

The primary objective of the present invention is to provide an adjustable holder assembly provided for adjustably holding mobile or portable phones.

In accordance with one aspect of the invention, there is provided an adjustable holder assembly comprising a holder body including a seat provided therein and having a socket opening formed therein, a portable phone for attaching and for being supported on the holder body, and an adjustable coupling device including a base having a first end engaged to the seat, and having a second end, and having a pair of flaps provided on the second end thereof for forming a channel between the flaps thereof, a shank including a first end having a first end bar received in the channel of the base and engaged between the flaps of the base, and including a second end having a second end bar provided thereon, a first fastener securing the first end bar of the shank to the flaps of the base at any selected angular position, a plug including a first end for plugging to a socket, and including a second end having a pair of plates provided thereon for forming a slot between the plates thereof and for selectively receiving the second end bar of the shank, and a second fastener securing the second end bar of the shank to the plates of the plug at any selected angular position.

The holder body includes a speaker for receiving phones from the portable phone. The holder body includes a holder body provided thereon for receiving and supporting the portable phone. The holder body includes a microphone coupled thereto for phone speaking purposes.

A coupling wire device is further provided and includes a first end having a first coupler for coupling to the holder body, and includes a second end having a second coupler for coupling to the portable phone.

A head set may further be provided for receiving and speaking phones, and the holder body includes a switch for switching between the head set and the portable phone.

The seat of the holder body includes a socket opening formed therein for receiving the base, and includes at least one lock notch formed therein and communicating with the socket opening thereof, the base includes at least one lock extension extended therefrom for engaging into the lock notch of the seat and for locking the base to the seat of the holder body.

The first end bar and the second end bar of the shank are offset from each other. Particularly, the first end bar and the second end bar of the shank are perpendicular with each other.

The first end bar of the shank includes a serrated surface formed thereon, at least one of the flaps of the base includes a serrated surface formed thereon and engaged with the serrated surface of the first end bar, for solidly securing the base to the shank at any selected angular position.

The second end bar of the shank includes a serrated surface formed thereon, at least one of the plates of the plug includes a serrated surface formed thereon and engaged with the serrated surface of the second end bar, for solidly securing the plug to the shank at any selected angular position.

The adjustable coupling device further includes a coupler for selectively coupling between the shank and the plug, the coupler includes a first end having a pair of ears provided thereon for forming a slot between the ears and for receiving the second end bar of the shank, and includes a second end having an end bar provided thereon for engaging into the slot of the plug and for adjustably securing to the plug at any angular position.

The coupler includes a passage formed therein for receiving electric wires. It is preferable that the shank also includes a passage formed therein for receiving electric wires and for allowing the plug to be electrically coupled to the base.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of an adjustable holder assembly in accordance with the present invention having a separate or remote head set;

FIG. 2 is a partial exploded view of the adjustable holder assembly;

FIGS. 3, 4, 5, 6 are partial exploded views similar to FIG. 2, illustrating the operation of the adjustable holder assembly;

FIG. 7 is a perspective view illustrating an adjustable coupling device for the adjustable holder assembly;

FIG. 8 is an exploded view of the adjustable coupling device for the adjustable holder assembly as shown in FIG. 7;

FIGS. 9, 10 are perspective views similar to FIG. 7, illustrating the operation of the adjustable coupling device for the adjustable holder assembly;

FIGS. 11, 12 are exploded views of the adjustable coupling device for the adjustable holder assembly as shown in FIGS. 9 and 10 respectively; and

FIG. 13 is a partial exploded view similar to FIGS. 2-6, illustrating the operation of the adjustable holder assembly.

### DETAILED DESCRIPTION OF THE PREFERRED EMBODIMENT

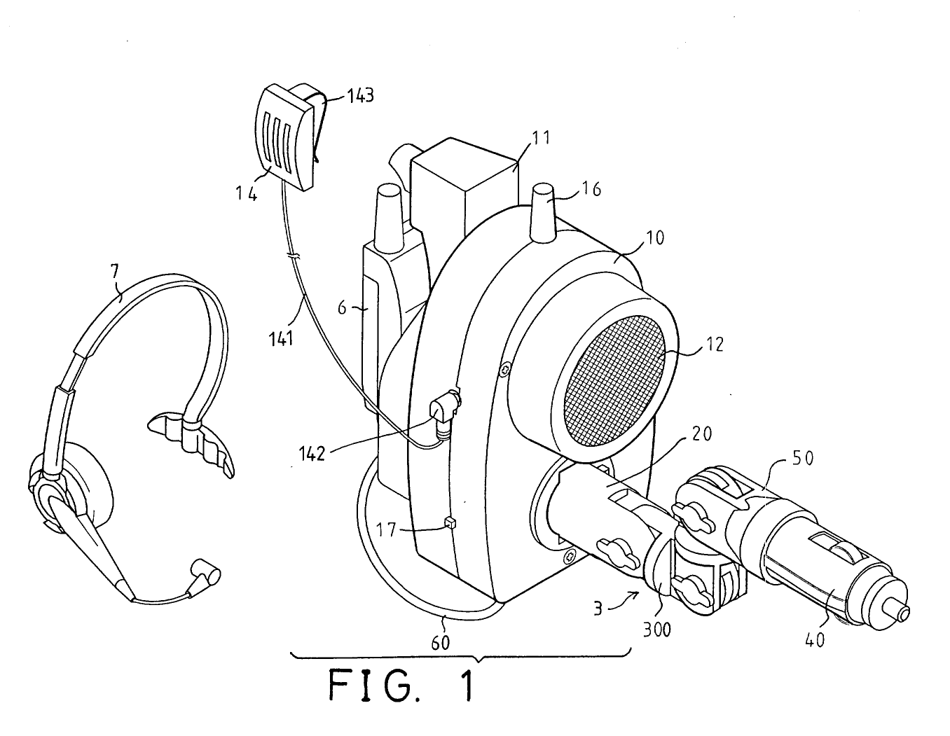

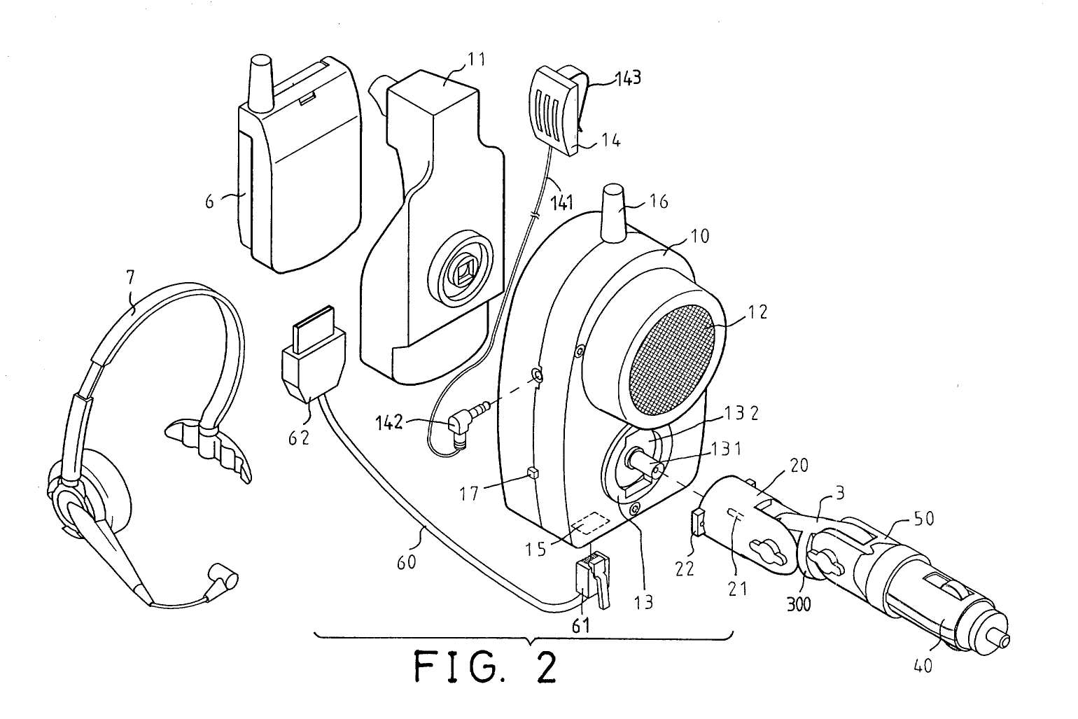

Referring to the drawings, and initially to FIGS. 1 and 2, an adjustable holder assembly in accordance with the present invention comprises a holder body 10 including a bracket 11 provided and attached to the front portion thereof for receiving or supporting a mobile or portable phone 6, and including a speaker 12 provided and disposed in the rear portion of the holder body 10 and selectively and electrically coupled to the portable phone 6 for allowing the phone or the sound from the portable phone 6 to be heard by the users without picking up or holding the portable phone. The holder body 10 may include an antenna 16 provided and disposed thereon for facilitating the signal receiving effect for the portable phone. A remote head set 7 may further be provided for receiving and speaking the phones.

The holder body 10 includes a socket 15 formed or provided in the bottom portion thereof. A coupling wire device 60 includes a coupler or plug 61 attached to one end thereof for coupling or plugging to the socket 15 of the holder body 10, and includes another coupler or plug 62 attached to the other end thereof for coupling or plugging to the portable phone 6, and for coupling the portable phone 6 to the holder body 10. A speaker 14 may further be provided and coupled to the holder body 10 with another cable 141 and another coupler or plug 142, and may be carried by the users, or may be hung or clamped onto the users and disposed closer to the mouth of the users, for allowing the users to easily speak the phone without moving toward the holder body 10 or without carrying the portable phone 6. The holder body 10 may include a switch 17 for switching between the remote head set 7 and the speaker 12 and microphone 14, and the portable phone 6 itself.

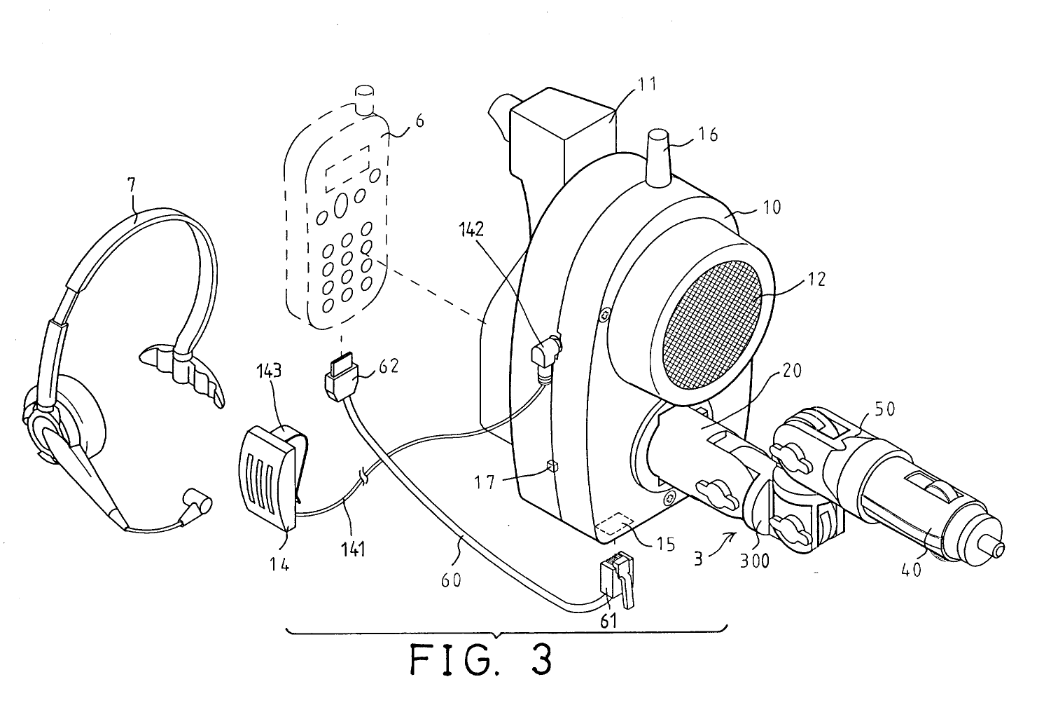

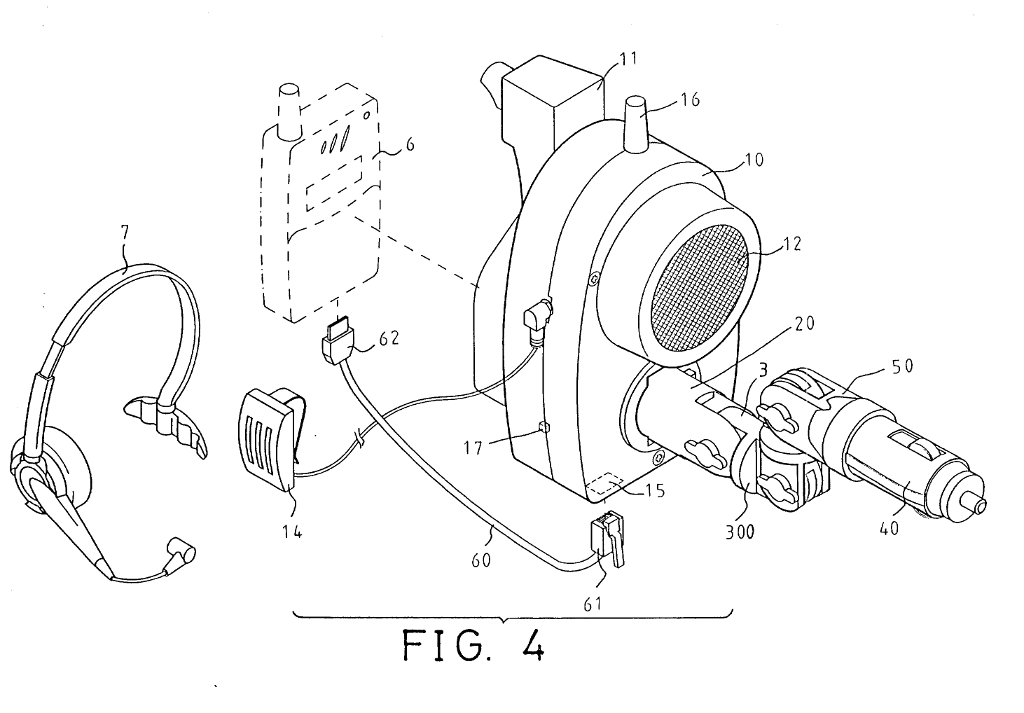

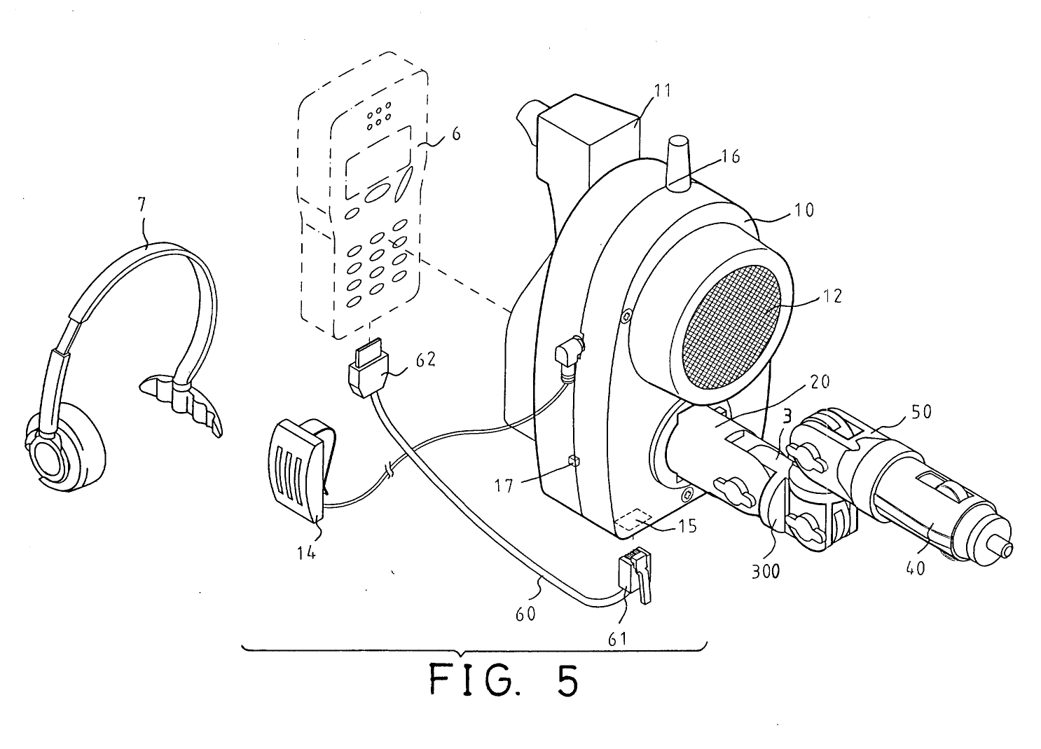

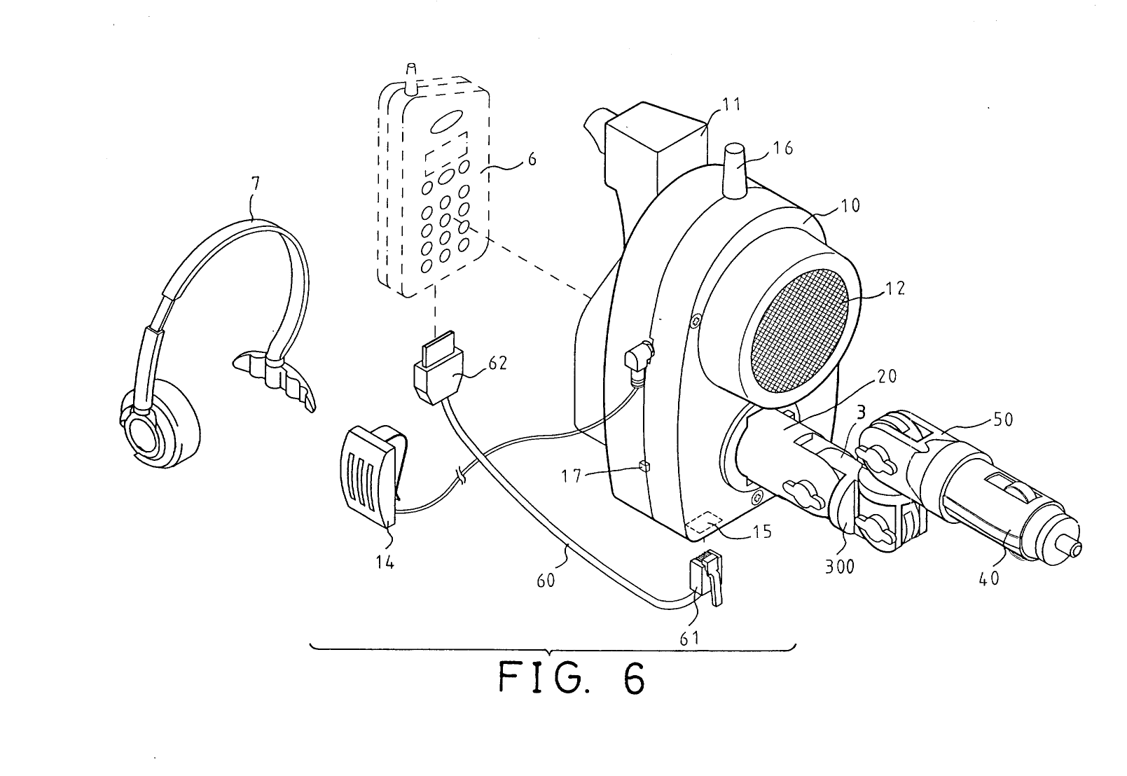

Referring next to FIGS. 3-6, and again to FIG. 2, the adjustable holder assembly in accordance with the present invention may comprise one or more coupling wire devices 60 each including a selected coupler or plug 62 for coupling or plugging to different or various kinds of portable phones 6.

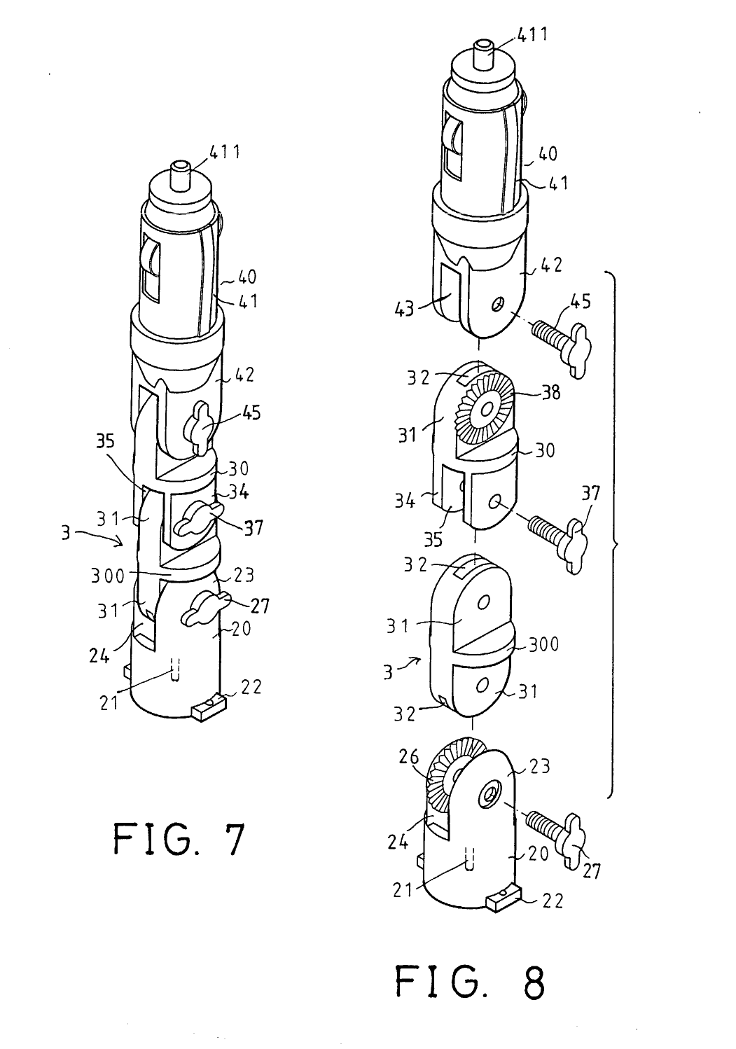

Referring again to FIG. 2, the holder body 10 includes a socket or a seat 13 provided in the rear portion thereof and having a conductor or a terminal 131 extended from a socket opening 132 thereof, and having one or more lock notches 133 formed therein and communicating with the socket opening 132 thereof. As shown in FIGS. 7-12, an adjustable coupling device includes a base 20 having a first end for engaging into the socket opening 132 of the seat 13, and having a hole or a socket opening or a socket 21 provided in the first end thereof for receiving the terminal 131 of the seat 13, and having one or more lock extensions 22 laterally extended outward from the first end thereof for engaging into the lock notches 133 of the seat 13. The lock extensions 22 may be rotated and engaged into the seat 13 for locking the base 20 to the seat 13 when the base 20 is rotated relative to the seat 13. The other end of the base 20 includes a pair of flaps 23 having a channel 24 formed or defined therebetween, and having a number of teeth or a serrated surface 26 formed in either or both of the flaps 23.

The adjustable coupling device further includes a shank 3 having a planer or bar-shaped structure, and having a peripheral flange 300 formed and provided in the middle portion thereof for forming or defining two end bars 31, and having a passage 32 formed therein, such as formed through the length thereof for receiving or threading with electric wires or the like. One of the end bars 31 of the shank 3 is engaged into the channel 24 of the base 20 and adjustably secured to the base 20 with a fastener 27. It is preferable that the end bars 31 of the shank 3 each includes a number of teeth or a serrated surface 33 (FIG. 11) formed thereon for engaging with the corresponding serrated surface 26 of the base 20 and for allowing the shank 3 to be adjustably and solidly secured to the base 20 at the required angular position.

The adjustable coupling device further includes a coupler 30 (FIGS. 7, 8, 10, 12) having an end bar 31 formed or provided on one end thereof, and having a pair of ears 34 formed or provided on the other end thereof for forming or defining a slot 35 between the ears 34 and for rotatably receiving the other end bar 31 of the shank 3. A fastener 37 may adjustably secure the ears 34 of the coupler 30 to the end bar 31 of the shank 3. The ears 34 of the coupler 30 and/or the end bar 31 of the shank 3 preferably each includes a number of teeth or a serrated surface 33 formed thereon for engaging with each other and for allowing the shank 3 to be adjustably and solidly secured to the coupler 30 at the required angular position. The coupler 30 also preferably includes a passage 32 formed therein, such as formed through the length thereof for receiving or threading with electric wires or the like.

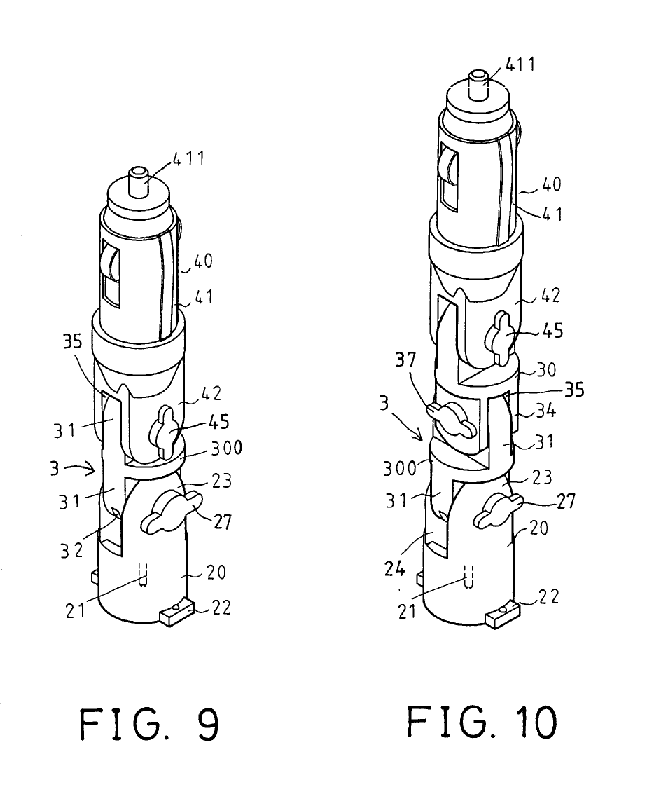

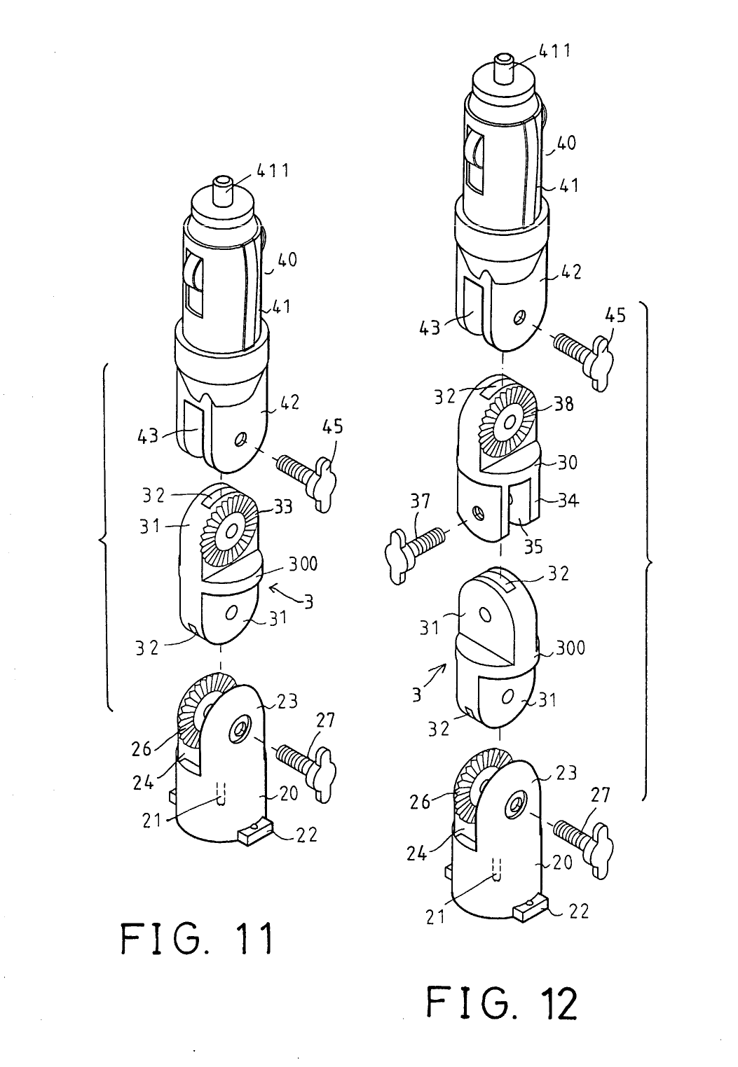

The adjustable coupling device further includes a plug 40 having a terminal 411 formed or provided on one end 41 thereof for plugging into the sockets, such as the sockets of the vehicles. The plug 40 includes a pair of plates 42 formed or provided on the other end thereof for forming or defining a slot 43 between the plates 42 and for rotatably receiving the end bar 31 of the coupler 30. A fastener 45 may adjustably secure the plates 42 of the plug 40 to the end bar 31 of the coupler 30. The plates 42 of the plug 40 and/or the end bar 31 of the coupler 30 preferably each includes a number of teeth or a serrated surface 38 (FIGS. 8, 12) formed thereon for engaging with each other and for allowing the coupler 30 to be adjustably and solidly secured to the plug 40 at the required angular position. As shown in FIGS. 9 and 11, the plug 40 may also be directly coupled to the shank 3 without the coupler 30. The plug 40 may be electrically coupled to the socket 21 of the base 20 with electric wires that may be engaged through the passages 32 of the shanks 3 and/or of the couplers 30.

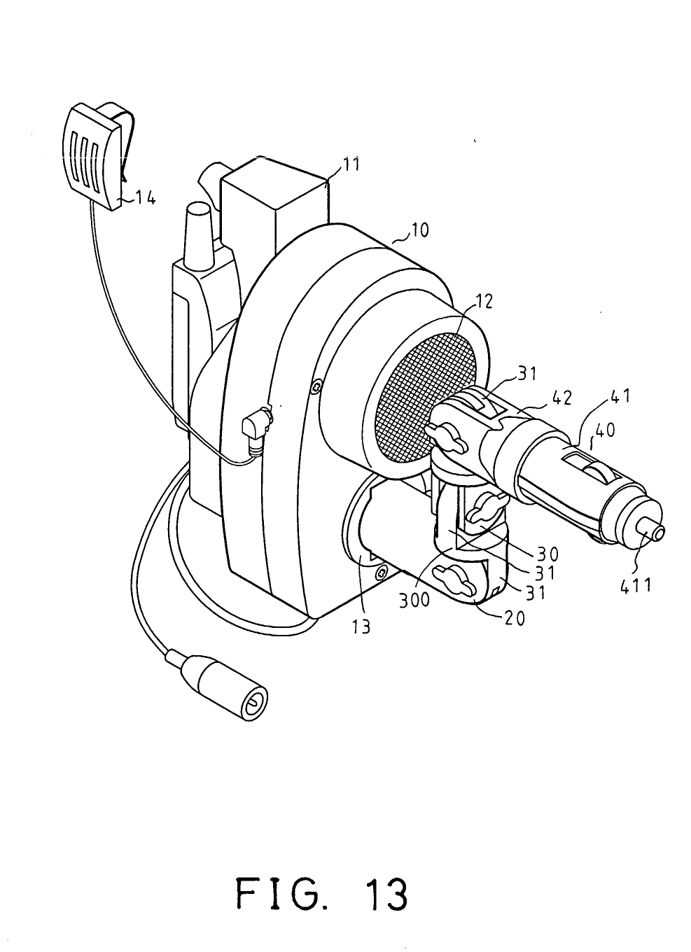

As shown in FIGS. 10, 12, 13, the adjustable coupling device may further include another shank 3 having the end bars 31 offset from each other, or the end bars 31 are perpendicular with each other, for allowing the coupler 30 to be secured to the base 20 at different angles. The shank 3 also includes a passage 32 formed therein, such as formed through the length thereof for receiving or threading with electric wires or the like. The adjustably holder assembly may include a number of shanks 3 and/or a number of couplers 30 for adjustably coupling the holder body 10 to the plug 40, and thus for allowing the holder body 10 to be adjustably plugged to the vehicle socket with the plug 40 and the shanks 3 and the couplers 30.

In operation, as shown in FIGS. 1-6 and 13, the holder body 10 may be solidly secured to the plug 40 at the required position or angular positions or distance with the shanks 3 and the couplers 30, and may thus be disposed and located closer to the users.

Accordingly, the adjustable holder assembly in accordance with the present invention may be used for adjustably holding mobile or portable phones.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An adjustable holder assembly comprising:
a) a holder body including a seat provided therein and having a socket opening formed therein,
b) a portable phone for attaching and for being supported on said holder body, and
c) an adjustable coupling device including:
i) a base having a first end engaged to said seat, and having a second end, and having a pair of flaps provided on said second end thereof for forming a channel between said flaps thereof,
ii) a shank including a first end having a first end bar received in said channel of said base and engaged between said flaps of said base, and including a second end having a second end bar provided thereon,
iii) a first fastener securing said first end bar of said shank to said flaps of said base at any selected angular position,
iv) a plug including a first end for plugging to a socket, and including a second end having a pair of plates provided thereon for forming a slot between said plates thereof and for selectively receiving said second end bar of said shank, and
v) a second fastener securing said second end bar of said shank to said plates of said plug at any selected angular position.

2. The adjustable holder assembly according to claim 1, wherein said holder body includes a speaker for receiving phones from said portable phone.

3. The adjustable holder assembly according to claim 1, wherein said holder body includes a holder body provided thereon for receiving and supporting said portable phone.

4. The adjustable holder assembly according to claim 1, wherein said holder body includes a microphone coupled thereto for phone speaking purposes.

5. The adjustable holder assembly according to claim 1 further comprising a coupling wire device including a first end having a first coupler for coupling to said holder body, and including a second end having a second coupler for coupling to said portable phone.

6. The adjustable holder assembly according to claim 1 further comprising a head set, and said holder body including a switch for switching between said head set and said portable phone.

7. The adjustable holder assembly according to claim 1, wherein said seat of said holder body includes at least one lock notch formed therein and communicating with said socket opening thereof, said base includes at least one lock extension extended therefrom for engaging into said at least one lock notch of said seat and for locking said base to said seat of said holder body.

8. The adjustable holder assembly according to claim 1, wherein said first end bar and said second end bar of said shank are offset from each other.

9. The adjustable holder assembly according to claim 1, wherein said first end bar and said second end bar of said shank are perpendicular with each other.

10. The adjustable holder assembly according to claim 1, wherein said first end bar of said shank includes a serrated surface formed thereon, at least one of said flaps of said base includes a serrated surface formed thereon and engaged with said serrated surface of said first end bar, for solidly securing said base to said shank at any selected angular position.

11. The adjustable holder assembly according to claim 1, wherein said second end bar of said shank includes a serrated surface formed thereon, at least one of said plates of said plug includes a serrated surface formed thereon and engaged with said serrated surface of said second end bar, for solidly securing said plug to said shank at any selected angular position.

12. The adjustable holder assembly according to claim 1, wherein said adjustable coupling device further includes a coupler for selectively coupling between said shank and said plug, said coupler includes a first end having a pair of ears provided thereon for forming a slot between said ears and for receiving said second end bar of said shank, and includes a second end having an end bar provided thereon for engaging into said slot of said plug and for adjustably securing to said plug at any angular position.

13. The adjustable holder assembly according to claim 12, wherein said coupler includes a passage formed therein for receiving electric wires.

14. The adjustable holder assembly according to claim 1, wherein said shank includes a passage formed therein for receiving electric wires.
